(19) United States
(12) Patent Application Publication
(10) Pub. No.: US 2013/0128092 A1
(43) Pub. Date: May 23, 2013

(54) CAMERA MODULE

(71) Applicants: Takayuki OGASAHARA, Kanagawa (JP); Risako UENO, Tokyo (JP); Mitsuyoshi KOBAYASHI, Kanagawa (JP); Katsuo IWATA, Kanagawa (JP); Atsuko KAWASAKI, Kanagawa (JP)

(72) Inventors: Takayuki OGASAHARA, Kanagawa (JP); Risako UENO, Tokyo (JP); Mitsuyoshi KOBAYASHI, Kanagawa (JP); Katsuo IWATA, Kanagawa (JP); Atsuko KAWASAKI, Kanagawa (JP)

(73) Assignee: Kabushiki Kaisha Toshiba, Tokyo (JP)

(21) Appl. No.: 13/530,595

(22) Filed: Jun. 22, 2012

(30) Foreign Application Priority Data
Nov. 17, 2011 (JP) 2011-251494

(51) Int. Cl. H04N 5/225

(52) U.S. Cl. 348/335; 348/E05.024

(57) ABSTRACT

According to one embodiment, a camera module includes an image sensor, a main lens system and a sublens group. The sublens group is provided in an optical path between the main lens system and the image sensor. The sublens group forms an image piece for every pixel block. The image piece corresponds to a part of a subject image. The sublens group is integrated with a support structure. The support structure serves to support the sublens group above the image sensor.

### CROSS-REFERENCE TO RELATED APPLICATIONS

This application is based upon and claims the benefit of priority from Japanese Patent Application No. 2011-251494, filed on Nov. 17, 2011; the entire contents of all of which are incorporated herein by reference.

### FIELD

Embodiments described herein relate generally to a camera module.

### BACKGROUND

In recent years, there is proposed a camera module having a compound eye constitution which can photograph a subject from a plurality of viewpoints at the same time. The camera module can perform such as estimating a subject distance and reconstruction a two-dimensional image by connecting images through an image processing for an image group photographed by using the compound eye constitution. The camera module can obtain depth information about the subject from a plurality of images through different viewpoints. The camera module executes an image processing such as refocus by utilizing the depth information, for example.

As a compound eye constitution of a camera module, for example, one in which a sublens array is provided between an image sensor and a main lens system for taking a light from a subject into the image sensor is known. In order to obtain accurate depth information about the subject, it is demanded to precisely ensure a distance from the image sensor in an installation of the sublens array. In a case in which precision in positioning of the sublens array is low, it is hard to obtain an image of high quality through an image processing.

### BRIEF DESCRIPTION OF THE DRAWINGS

FIG. 1 is a block diagram showing a schematic constitution of a camera module according to a first embodiment;

FIG. 2 is a schematic sectional view showing a partial constitution including an image pickup optical system and an image sensor in the camera module;

FIG. 3 is a sectional view showing a compound eye sublens structure and the image sensor;

FIG. 4 is a schematic plane view showing the image sensor side in the compound eye sublens structure;

FIG. 5 is a schematic plane view showing an incident side in the image sensor;

FIG. 6 is an explanatory view showing an image piece generated by the image sensor;

FIG. 7 is an explanatory view showing a reconstruction processing for a subject image through an ISP;

FIG. 8 is a sectional view showing a compound eye sublens structure, a cover glass and an image sensor in a camera module according to a variant of the first embodiment;

FIG. 9 is a schematic sectional view showing a partial constitution including an image pickup optical system and an image sensor in a camera module according to a second embodiment;

FIG. 10 is a sectional view showing a compound eye sublens structure, a cover glass and a package in a camera module according to a variant of the second embodiment;

FIG. 11 is a schematic sectional view showing a partial constitution including an image pickup optical system and an image sensor in a camera module according to a third embodiment;

FIG. 12 is a schematic sectional view showing a partial constitution including an image pickup optical system and an image sensor in a camera module according to a variant of the third embodiment; and

FIG. 13 is a schematic plane view showing the image sensor side in the compound eye sublens structure.

### DETAILED DESCRIPTION

In general, according to one embodiment, a camera module includes an image sensor, a main lens system and a sublens group. The image sensor has a pixel cell disposed in an array. The image sensor picks up a subject image. The main lens system takes a light from the subject into the image sensor. The sublens group is provided in an optical path between the main lens system and the image sensor. The sublens group forms an image piece for every pixel block. The image piece corresponds to a part of the subject image. The pixel block is constituted by a plurality of pixel cells. The sublens group is integrated with a support structure. The support structure serves to support the sublens group over the image sensor.

Exemplary embodiments of a camera module will be explained below in detail with reference to the accompanying drawings. It should be noted that the present invention is not limited to these embodiments.

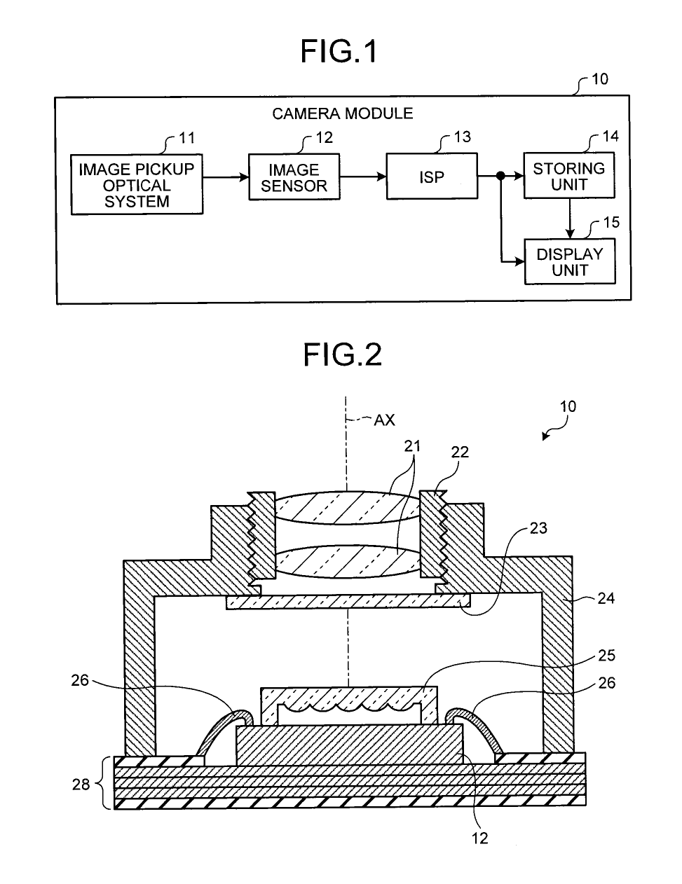

FIG. 1 is a block diagram showing a schematic constitution of a camera module according to a first embodiment. A camera module 10 has an image pickup optical system 11, an image sensor 12, an image signal processor (ISP) 13, a storing unit 14 and a display unit 15. The camera module 10 is a digital camera, for example. The camera module 10 may be an electronic apparatus other than the digital camera, for example, a portable terminal having a camera, or the like.

The image pickup optical system 11 takes in a light from a subject and forms a subject image. The image sensor 12 picks up the subject image. The ISP 13 executes a signal processing for an image signal obtained through the image pickup in the image sensor 12. The storing unit 14 stores the image through the signal processing in the ISP 13. The storing unit 14 outputs an image signal to the display unit 15 in response to an operation of a user, or the like. The display unit 15 displays an image in response to the image signal input from the ISP 13 or the storing unit 14. The display unit 15 is a liquid crystal display, for example.

FIG. 2 is a schematic sectional view showing a partial constitution including the image pickup optical system and the image sensor in the camera module. A main lens system 21 takes a light from the subject into the image sensor 12. A lens holder 22 holds each lens constituting the main lens system 21. An IR cut filter 23 shields infrared rays (IR) and transmits a visible light therethrough.

The image sensor 12 is provided on a flexible board 28. A bonding wire 26 connects an electrode (not shown) in the flexible board 28 to the image sensor 12. A compound eye sublens structure 25 is provided on the image sensor 12. The compound eye sublens structure 25 is set to be a structure obtained by integrating a sublens array and a spacer which will be described later. The image pickup optical system 11 is constituted to include the main lens system 21 and a sublens array.

An outer cover 24 covers a portion of the flexible board 28 in which the image sensor 12 and the bonding wire 26 are disposed, and thus constitutes a space in an inner part. The lens holder 22 is fitted in an opening formed on the outer cover 24. The IR cut filter 23 is attached to close the opening from an inside of the outer cover 24. Note that, it is sufficient that a position of the IR cut filter 23 is placed in an optical path from the subject to the image sensor 12, and it is assumed that the position can be properly varied.

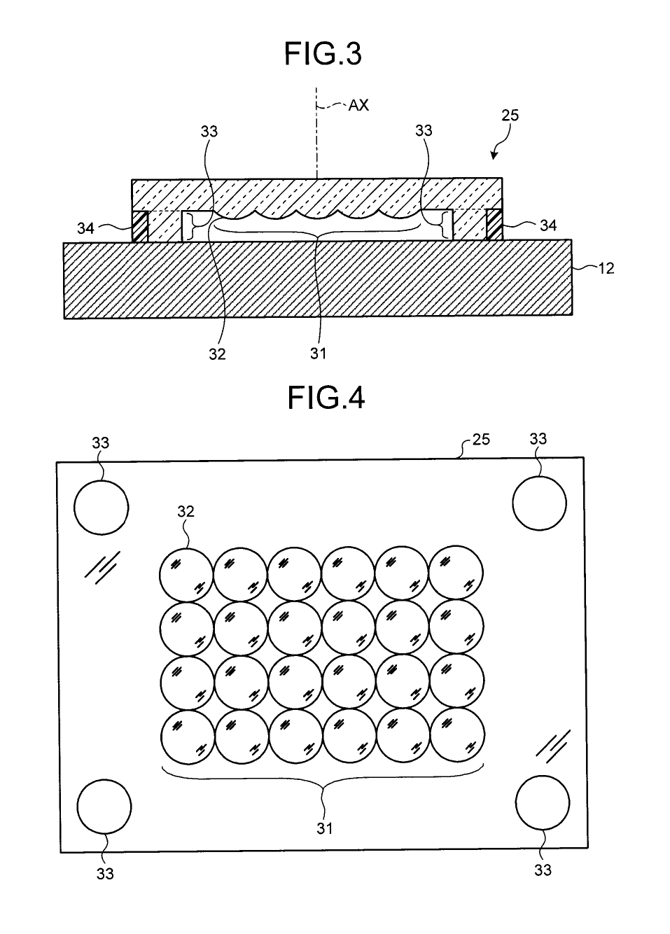

FIG. 3 is a sectional view showing the compound eye sublens structure and the image sensor. FIG. 4 is a schematic plane view showing the image sensor side in the compound eye sublens structure.

A sublens array 31 functions as a sublens group for forming an image piece for every pixel block. The sublens array 31 is formed on a surface of the compound eye sublens structure 25 which is opposed to the image sensor 12. The sublens array 31 includes a plurality of sublenses 32 disposed in an array. The sublens array 31 is provided in a position of an imaging plane of the main lens system 21 in an optical path between the main lens system 21 and the image sensor 12, for example. The image sensor 12, the sublens array 31 and the IR cut filter 23 (see FIG. 2) are disposed on an optical axis AX of the main lens system 21.

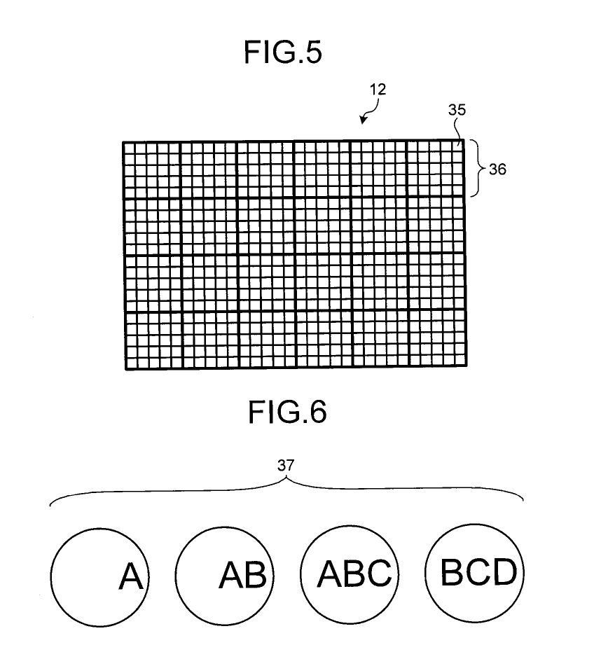

FIG. 5 is a schematic plane view showing an incident side of the image sensor. The image sensor 12 includes a pixel cell 35 disposed in an array. A pixel block 36 constituted by the pixel cells 35 is set into the image sensor 12. The pixel block 36 is constituted by 25 pixel cells 35, in which five pixel cells 35 are disposed in an array in a row direction and five pixel cells 35 are disposed in an array in a column direction. Note that, it is assumed that the number of the pixel cells 35 included in the pixel block 36 can be properly varied.

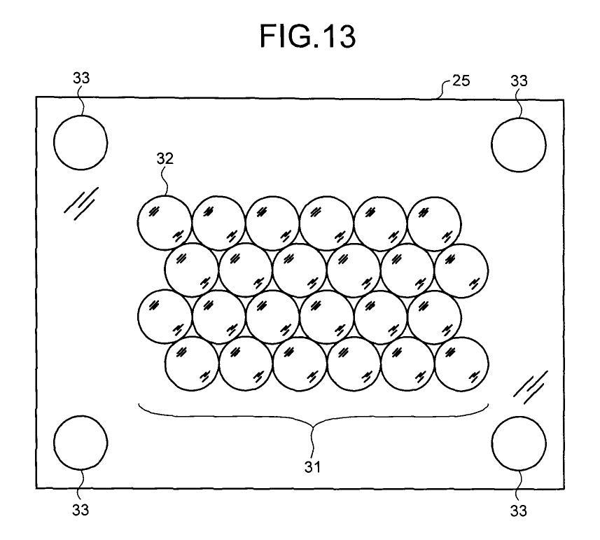

The sublens 32 is provided corresponding to each of the pixel blocks 36. Each sublens 32 forms, as an image piece, a subject image formed by the main lens system 21. The image piece corresponds to a part of the subject image. The sublens array 31 forms the image piece for every pixel block 36. Note that, it is assumed that the array of the sublens 32 may be any of a tetragonal lattice array shown in FIG. 4, a hexagonal closest array shown in FIG. 13 and the like.

A spacer 33 functions as a support structure for supporting the sublens array 31 over the image sensor 12. The sublens array 31 is integrated with the spacer 33. As shown in FIG. 4, the spacer 33 is provided in the vicinity of four corners of a rectangular surface constituting the compound eye sublens structure 25 in a peripheral region of a portion in which the sublens array 31 is formed. The spacer 33 is formed like a column, for example. Note that, the shape, position, number and the like of the spacer 33 are not restricted to the case shown in FIG. 4 but may be properly varied. The spacer 33 may take a shape of a frame surrounding the portion in which the sublens array 31 is formed, for example.

An adhesive material 34 fixes the compound eye sublens structure 25 onto the image sensor 12. The adhesive material 34 firmly fixes the compound eye sublens structure 25 to the image sensor 12 in a portion of an outer edge part of the compound eye sublens structure 25 in which the spacer 33 is provided, for example. In this example, the compound eye sublens structure 25 also functions as a cover glass for covering the image sensor 12. The compound eye sublens structure 25 is constituted by using a transparent member. The compound eye sublens structure 25 is formed to take a desirable shape by mold transfer, for example.

For instance, in a case in which a distance between the image sensor 12 and the main lens system 21 is set to be 500 μm, a distance between the image sensor 12 and the sublens array 31 is 50 μm. The sublens array 31 is integrated with the spacer 33 formed in a desirable length in a direction of the optical axis AX and is supported on the image sensor 12 through the spacer 33.

Consequently, the sublens array 31 has the distance from the image sensor 12 which is ensured accurately, and can be installed with high positioning precision. By attaching the compound eye sublens structure 25 in place of a cover glass to be generally fixed to the image sensor 12, the camera module 10 can easily implement the compound eye constitution with high positioning precision.

In the first embodiment, it is possible to position the sublens array 31 with high precision by causing the spacer 33 formed in the desirable length to abut on the image sensor 12. If the distance between the sublens array 31 and the image sensor 12 can be ensured accurately, the spacer 33 may be fixed to the image sensor 12 with the adhesive material 34 provided therebetween. It is assumed that a mode for fixing the spacer 33 to the image sensor 12 can be properly changed if the distance between the sublens array 31 and the image sensor 12 can be determined accurately. Note that, the spacer 33 itself may be constituted by the adhesive material 34.

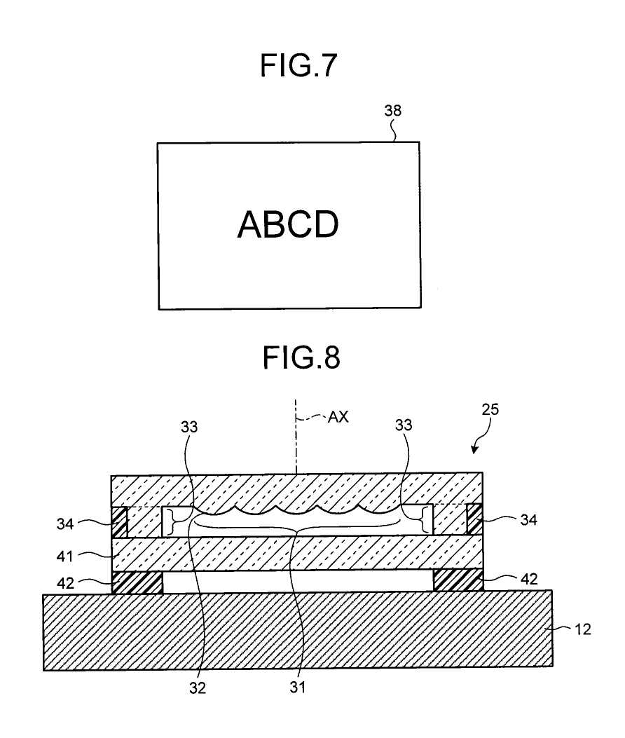

FIG. 6 is an explanatory view showing an image piece generated by the image sensor. FIG. 7 is an explanatory view showing a reconstruction processing for a subject image through the ISP. Herein, there is taken, as an example, a case in which an image of a character string of “ABCD” is picked up by the image sensor 12 and the reconstruction processing for the subject image is executed.

A visual field imaged as an image piece 37 by each sublens 32 has an overlapping range corresponding to a parallax over the imaging plane of the main lens system 21. The image of the character string of “ABCD” is picked up, by the image sensor 12, as the image piece 37 in which the overlapping portion is gradually different as shown in FIG. 6, for example.

The ISP 13 connects the image pieces 37 together in such a manner that the overlapping portions are coincident with each other, thereby reconstructing the subject image. The image piece 37 is reconstructed into a subject image 38 including the character string of “ABCD” as shown in FIG. 7 through such a signal processing as to cause the characters of “A”, “B”, “C” and “D” to be coincident with each other.

The camera module 10 according to the first embodiment can ensure high positioning precision for the compound eye constitution using the sublens array 31. Consequently, the camera module 10 can acquire an image of high quality through an image processing for an image group photographed by using the compound eye constitution.

Note that, the sublens array 31 is integrated with a support structure and is preferably provided in the optical path between the main lens system 21 and the image sensor 12, and an installation position may be properly changed. The sublens array 31 is provided on an emitting surface at the image sensor 12 side in the compound eye sublens structure 25. The sublens array 31 may also be provided on an incident surface at the IR cut filter 23 side in the compound eye sublens structure 25, for example.

FIG. 8 is a sectional view showing a compound eye sublens structure, a cover glass and an image sensor in a camera module according to a variant of the first embodiment. In the present variant, a cover glass 41 is provided between an image sensor 12 and a compound eye sublens structure 25. The cover glass 41 covers the image sensor 12. A transparent plate-shaped member is used for the cover glass 41.

An adhesive material 42 fixes the cover glass 41 to the image sensor 12 around a region through which a light from a sublens array 31 is transmitted. It is assumed that the adhesive material 42 accurately determines a distance between the image sensor 12 and the cover glass 41 and can thus fix the cover glass 41.

A spacer 33 supports the sublens array 31 over the cover glass 41. The sublens array 31 is formed on a surface of the compound eye sublens structure 25 which is opposed to the cover glass 41.

An adhesive material 34 fixes the compound eye sublens structure 25 onto the cover glass 41. The adhesive material 34 firmly fixes the compound eye sublens structure 25 and the cover glass 41 to each other in a portion of an outer edge part of the compound eye sublens structure 25 in which the spacer 33 is provided, for example.

A length of the spacer 33 in a direction of an optical axis AX is determined to have a desirable distance between the image sensor 12 and the sublens array 31 with the cover glass 41 interposed therebetween. In the present variant, it is possible to position the sublens array 31 with high precision by causing the spacer 33 formed in a desirable length to abut on the cover glass 41.

Also in the present variant, the sublens array 31 can accurately ensure the distance from the image sensor 12, thereby carrying out an installation with high positioning precision. The camera module 10 can easily implement a compound eye constitution with high positioning precision by attaching the compound eye sublens structure 25 onto the cover glass 41 to be generally fixed to the image sensor 12.

Note that, in the present variant, it is assumed that a mode for fixing the spacer 33 to the cover glass 41 can be varied properly if the distance between the sublens array 31 and the image sensor 12 can be determined accurately.

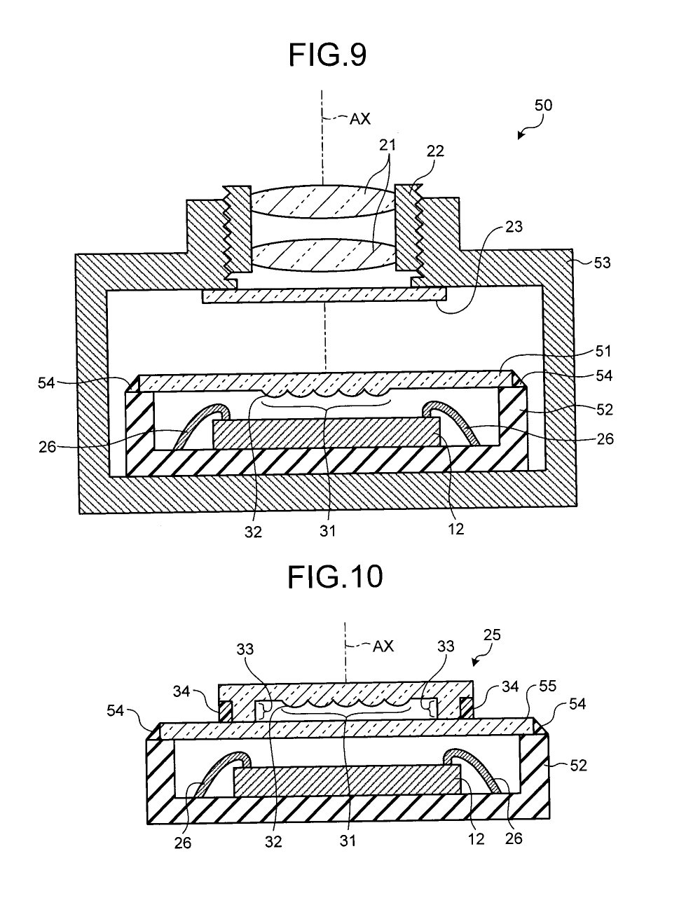

FIG. 9 is a schematic sectional view showing a partial constitution including an image pickup optical system and an image sensor in a camera module according to a second embodiment. A camera module 50 according to the present embodiment has the same schematic constitution as that of the camera module 10 shown in FIG. 1. The same portions as those in the first embodiment have the same reference numerals and repetitive description will not be repeated appropriately.

An image sensor 12 is provided inside a package 52. A bonding wire 26 connects an electrode (not shown) in the package 52 to the image sensor 12. The package 52 has a bottom portion where the image sensor 12 is installed and a side portion which surrounds a periphery of the image sensor 12.

A cover glass 51 is attached to close a top surface on a side where a light is incident in the package 52. An outer cover 53 constitutes a space in an inner part. The package 52 is accommodated inside the outer cover 53. A lens holder 22 is fitted in an opening formed on the outer cover 53. An IR cut filter 23 is attached to close the opening from an inside of the outer cover 53.

A sublens array 31 is formed on a surface of the cover glass 51 which is opposed to the image sensor 12. The image sensor 12, the sublens array 31 and the IR cut filter 23 are disposed on an optical axis AX of a main lens system 21.

The package 52 functions as a support structure for supporting, on the image sensor 12, the cover glass 51 where the image sensor 12 is formed. The package 52 is integrated with the cover glass 51 where the image sensor 12 is formed.

An adhesive material 54 fixes the cover glass 51 onto the package 52. The adhesive material 54 firmly fixes the cover glass 51 to the package 52 in an outer edge part of the cover glass 51, for example. The cover glass 51 is formed to take a desirable shape through mold transfer, for example.

A height of a side portion in a direction of the optical axis AX in the package 52 is determined to have a desirable distance between the image sensor 12 and the sublens array 31. The sublens array 31 is integrated with the package 52 formed in a desirable length with respect to the direction of the optical axis AX and is supported above the image sensor 12 through the package 52.

Consequently, the sublens array 31 has the distance from the image sensor 12 which is accurately ensured, and can be installed with high positioning precision. The camera module 50 can easily implement a compound eye constitution with high positioning precision by attaching, to the package 52, the cover glass 51 having the sublens array 31 formed thereon.

The camera module 50 according to the second embodiment can ensure high positioning precision for the compound eye constitution using the sublens array 31. Thus, the camera module 50 can acquire an image of high quality through an image processing for an image group photographed by using the compound eye constitution.

In the second embodiment, it is possible to position the sublens array 31 with high precision by causing the cover glass 51 to abut on an end face of the side portion formed to have the desirable height in the package 52. If the distance between the sublens array 31 and the image sensor 12 can be ensured accurately, the over glass 51 may be fixed to the package 52 with the adhesive material 54 interposed therebetween. It is assumed that a mode for fixing the cover glass 51 to the package 52 can be varied properly if the distance between the sublens array 31 and the image sensor 12 can be determined accurately.

FIG. 10 is a sectional view showing a compound eye sublens structure, a cover glass and a package in a camera module according to a variant of the second embodiment. In the present variant, the same compound eye sublens structure 25 as that in the first embodiment is provided on a cover glass 55.

The cover glass 55 is attached to close a top surface on a side where a light is incident in a package 52. A transparent plate-shaped member is used for the cover glass 55. An adhesive material 54 fixes the cover glass 55 onto the package 52.

The compound eye sublens structure 25 is constituted by integrating a sublens array 31 with a spacer 33. The spacer 33 supports the sublens array 31 above the cover glass 55. An adhesive material 34 fixes the compound eye sublens structure 25 onto the cover glass 55. The adhesive material 34 firmly fixes the compound eye sublens structure 25 to the cover glass 55 in a portion of an outer edge part of the compound eye sublens structure 25 in which the spacer 33 is provided, for example.

A height of a side portion in a direction of an optical axis AX in the package 52 is determined to have a desirable distance between an image sensor 12 and the sublens array 31 with the cover glass 55 interposed therebetween. Also in the present variant, the sublens array 31 has the distance from the image sensor 12 which is ensured accurately, and can be installed with high positioning precision. A camera module 50 can easily implement a compound eye constitution with high positioning precision by attaching the compound eye sublens structure 25 onto the cover glass 55 to be generally fixed to the package 52.

Note that, in the present variant, it is assumed that a mode for fixing the spacer 33 to the cover glass 55 can be changed properly if the distance between the sublens array 31 and the image sensor 12 can be determined accurately.

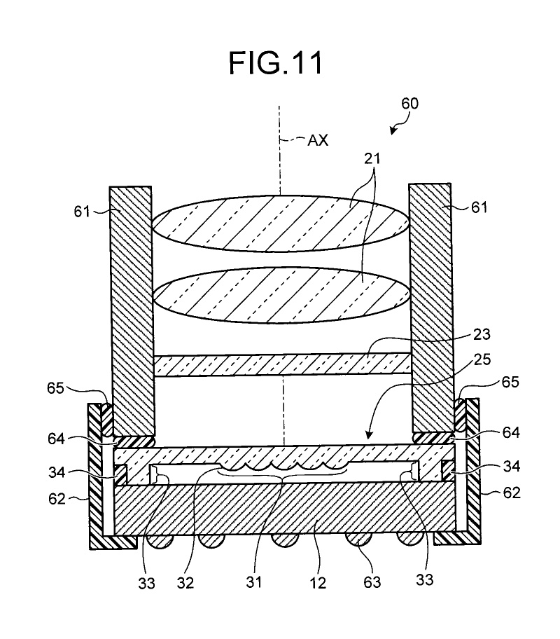

FIG. 11 is a schematic sectional view showing a partial constitution including an image pickup optical system and an image sensor in a camera module according to a third embodiment. A camera module 60 according to the present embodiment has the same schematic structure as that of the camera module 10 shown in FIG. 1. The same portions as those in the first embodiment have the same reference numerals and repetitive description will not be repeated appropriately.

A solder ball 63 is provided on a lower side of a circuit board (not shown) on which an image sensor 12 is mounted. A compound eye sublens structure 25 is provided on the image sensor 12. The compound eye sublens structure 25 is constituted by integrating a sublens array 31 with a spacer 33. The spacer 33 supports the sublens array 31 above the image sensor 12. An adhesive material 34 fixes the compound eye sublens structure 25 onto the image sensor 12.

A lens holder 61 holds each lens constituting a main lens system 21 and an IR cut filter 23. The lens holder 61 is provided on the image sensor 12 through the compound eye sublens structure 25. An adhesive material 64 fixes the lens holder 61 onto the compound eye sublens structure 25. A shield unit 62 seals a part of the lens holder 61 and peripheries of the compound eye sublens structure 25 and the image sensor 12. A lower end of the shield unit 62 is fixed to a lower portion of the image sensor 12. An upper end of the shield unit 62 is fixed to the lens holder 61 through an adhesive material 65.

A length of the spacer 33 in a direction of an optical axis AX is determined to have a desirable distance between the image sensor 12 and the sublens array 31. In the third embodiment, it is possible to position the sublens array 31 with high precision by causing the spacer 33 formed in the desirable length to abut on the image sensor 12.

Consequently, the sublens array 31 has the distance from the image sensor 12 which is ensured accurately, and can be thus installed with high positioning precision. The camera module 60 can easily implement a compound eye constitution with high positioning precision by attaching the compound eye sublens structure 25 in place of a cover glass to be generally fixed to the image sensor 12.

The camera module 60 according to the third embodiment can ensure the high positioning precision for the compound eye constitution using the sublens array 31. Consequently, the camera module 60 can acquire an image of high quality through an image processing for an image group photographed by using the compound eye constitution.

It is assumed that a mode for fixing the spacer 33 to the image sensor 12 can be changed properly if the distance between the sublens array 31 and the image sensor 12 can be determined accurately. Note that, the spacer 33 itself may be constituted by the adhesive material 34.

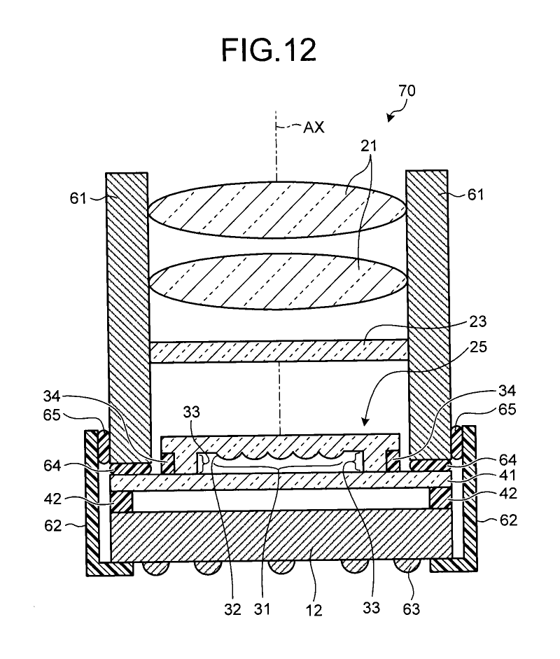

FIG. 12 is a schematic sectional view showing a partial constitution including an image pickup optical system and an image sensor in a camera module according to a variant of the third embodiment. A camera module 70 according to the present variant has the same schematic constitution as that of the camera module 10 shown in FIG. 1.

In the present variant, a cover glass 41 is provided between an image sensor 12 and a lens holder 61. The cover glass 41 covers the image sensor 12. The lens holder 61 is provided on the image sensor 12 through the cover glass 41. An adhesive material 64 fixes the lens holder 61 onto the cover glass 41. A shield unit 62 seals a part of the lens holder 61 and peripheries of the cover glass 41 and the image sensor 12.

An adhesive material 42 fixes the cover glass 41 to the image sensor 12. It is assumed that the adhesive material 42 accurately determines a distance between the image sensor 12 and the cover glass 41 and can thus fix the cover glass 41. A compound eye sublens structure 25 is provided on the cover glass 41. The compound eye sublens structure 25 is positioned on an inside of the lens holder 61.

A spacer 33 supports a sublens array 31 above the cover glass 41. An adhesive material 34 fixes the compound eye sublens structure 25 onto the cover glass 41. The adhesive material 34 firmly fixes the compound eye sublens structure 25 to the cover glass 41 in a portion of an outer edge part of the compound eye sublens structure 25 in which the spacer 33 is provided, for example.

A length of the spacer 33 in a direction of an optical axis AX is determined to have a desirable distance between the image sensor 12 and the sublens array 31 with the cover glass 41 interposed therebetween. Also in the present variant, the sublens array 31 has the distance from the image sensor 12 which is accurately ensured, and can be installed with high positioning precision. The camera module 70 can easily implement a compound eye constitution with high positioning precision by attaching the compound eye sublens structure 25 onto the cover glass 41 to be generally fixed to the image sensor 12.

Note that, in the present variant, it is assumed that a mode for fixing the spacer 33 to the cover glass 41 can be changed properly if the distance between the sublens array 31 and the image sensor 12 can be determined accurately.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A camera module comprising:
an image sensor including a pixel cell disposed in an array and configured to pick up a subject image;
a main lens system configured to take a light from a subject into the image sensor; and
a sublens group provided in an optical path between the main lens system and the image sensor and configured to form an image piece corresponding to a part of the subject image for every pixel block constituted by a plurality of the pixel cells,
wherein the sublens group is integrated with a support structure configured to support the sublens group above the image sensor.

2. The camera module according to claim 1, wherein the sublens group and the support structure constitute a cover glass covering the image sensor.

3. The camera module according to claim 2, wherein a spacer to be the support structure abuts on the image sensor.

4. The camera module according to claim 3, comprising an adhesive material configured to firmly fix a structure obtained by integrating the sublens group with the spacer to the image sensor in a portion of the structure in which the spacer is provided.

5. The camera module according to claim 2, wherein the sublens group is provided on a surface in a structure obtained by integrating the sublens group with the spacer which is opposed to the image sensor.

6. The camera module according to claim 1, comprising a cover glass configured to cover the image sensor, and
the support structure supporting the sublens group above the cover glass.

7. The camera module according to claim 6, wherein a spacer to be the support structure abuts on the cover glass.

8. The camera module according to claim 7, comprising an adhesive material configured to firmly fix a structure obtained by integrating the sublens group with the spacer to the cover glass in a portion of the structure in which the spacer is provided.

9. The camera module according to claim 6, wherein the sublens group is provided on a surface in a structure obtained by integrating the sublens group with the spacer which is opposed to the cover glass.

10. The camera module according to claim 1, comprising a cover glass configured to cover the image sensor,
the sublens group being formed on the cover glass, and
the support structure supporting the cover glass.

11. The camera module according to claim 10, comprising a package having the cover glass attached thereto and configured to accommodate the image sensor therein, and
the package functioning as the support structure.

12. The camera module according to claim 11, wherein the package includes a side portion surrounding a periphery of the image sensor, and
the cover glass abuts on the side portion.

13. The camera module according to claim 12, comprising an adhesive material configured to firmly fix the cover glass to the package in an outer edge part of the cover glass.

14. The camera module according to claim 10, wherein the sublens group is formed on a surface in the cover glass which is opposed to the image sensor.

15. The camera module according to claim 1, comprising:
a package configured to accommodate the image sensor therein; and
a cover glass attached to the package,
wherein the support structure supporting the sublens group above the cover glass.

16. The camera module according to claim 1, comprising a lens holder configured to hold the main lens system,
wherein the lens holder is provided on the image sensor.

17. The camera module according to claim 16, wherein a structure obtained by integrating the sublens group with the support structure is provided on the image sensor, and
the lens holder is provided on the image sensor through the structure.

18. The camera module according to claim 17, wherein a spacer to be the support structure abuts on the image sensor.

19. The camera module according to claim 16, comprising a cover glass configured to cover the image sensor,
wherein the sublens group supports the sublens group above the cover glass.

20. The camera module according to claim 1, wherein the sublens group is provided in a position on an imaging plane of the main lens system.
